(19) United States
(12) Patent Application Publication
(10) Pub. No.: US 2026/0108970 A1
(43) Pub. Date: Apr. 23, 2026

(54) METHOD AND SYSTEM FOR DRIVING SOFT WELDING GUN

(71) Applicant: Suzhou Iview Intelligent Technology Co., Ltd., Suzhou (CN)

(72) Inventors: Yongzhe LI, Nanjing (CN); Wenqi ZHONG, Nanjing (CN); Jinlong ZHAO, Suzhou (CN); Zhenyu WANG, Suzhou (CN); Weijuan ZHAO, Suzhou (CN); Zhonghua NI, Nanjing (CN)

(21) Appl. No.: 19/423,706

(22) Filed: Dec. 17, 2025

(30) Foreign Application Priority Data
Feb. 25, 2025 (CN) 2025102059972

(51) Int. Cl. B23K 9/095; B23K 9/12; B23K 37/02

(52) U.S. Cl. CPC B23K 9/0953; B23K 9/124; B23K 37/0247

(57) ABSTRACT

This application relates to a method and a system for driving a soft welding gun. The method includes: obtaining a displacement of a driving rope; calculating a reference value of a welding gun tip pose based on the displacement of the driving rope; obtaining a welding current and a welding voltage; calculating a change value of a distance between a welding gun nozzle tip and a workpiece based on the welding current and the welding voltage; and inputting the reference value of the welding gun tip pose and the change value of the distance between the welding gun nozzle tip and the workpiece to a preset welding gun pose estimation model, and solving to obtain a real-time pose of the soft welding gun tip.

### TECHNICAL FIELD

This application relates to the field of pose sensing technologies for soft robotic arms, and in particular, to a method and system for driving a soft welding gun.

### BACKGROUND

There are many complex welded structures in application fields such as marine engineering, petrochemical pipelines, national defense and military industry, and shipbuilding. Generally, welding operations are performed in confined spaces. Conventional welding robot devices and welding torches have fixed geometrical dimensions, and are not suitable for welding operations in confined spaces. Currently, welding operations in confined spaces usually need to be completed manually, which not only is time-consuming and laborious, but also makes it difficult to ensure consistency of welding quality.

For example, Chinese Patent No. CN115091439B discloses a modular soft robotic arm system based on a dielectric elastic body and a control method therefor, and belongs to the field of soft robots. The soft robotic arm system includes a mounting frame, an upper computer, a camera, a high-voltage module, a signal acquisition module, and a modular soft robotic arm based on a dielectric elastic body. The camera is configured to detect a pose of the robotic arm. The high-voltage module includes a voltage generation module, a voltage amplification module, and a power supply module, and is configured to provide a driving voltage for the robotic arm. The signal acquisition module is configured to detect the driving voltage for the robotic arm. The modularized soft robotic arm based on the dielectric elastic body includes a plurality of soft units that are connected in series, and each soft unit can implement axial elongation and bending in any direction under the driving voltage. Therefore, the robotic arm has a hyper-redundant degree of freedom, a lightweight structure, and flexible movement. In the present invention, attitude information of the soft robotic arm can be shot by using the camera, and real-time attitude control can be performed on the soft robotic arm based on the attitude information, leading to simple operations, strong robustness, and a good control effect.

However, an existing soft welding gun lacks a dedicated sensing apparatus, and consequently, the soft welding gun cannot obtain a tip pose in real time during welding. A welding gun nozzle tip deviates from a predetermined process parameter, which is prone to poor forming and welding.

### SUMMARY

### 1. Problem to be Solved

In view of this, to resolve the foregoing technical problems, it is necessary to provide a soft welding gun capable of obtaining a tip pose in real time, and a method and a system for driving a soft welding gun.

### 2. Technical Solution

According to a first aspect, this application provides a soft welding gun. The soft welding gun includes: a welding machine, where a welding cable is arranged on the welding machine, a nozzle is arranged on the end of the welding cable away from the welding machine, an elastic member is sleeved on the welding cable, and a driving rope for controlling extension and retraction of the elastic member is arranged on the nozzle.

According to a second aspect, this application provides a method for driving the soft welding gun. The method includes:
obtaining a displacement of a driving rope;
calculating a reference value of a soft welding gun tip pose based on the displacement of the driving rope;
obtaining a welding current and a welding voltage;
calculating the change value of the distance between a welding gun nozzle tip and a workpiece based on the welding current and the welding voltage; and
inputting the reference value of the soft welding gun tip pose and the change value of the distance between the welding gun nozzle tip and the workpiece to a preset welding gun pose estimation model, and solving to obtain a real-time pose of the soft welding gun tip.

In one of the embodiments, after the calculating a reference value of a soft welding gun tip pose based on the displacement of the driving rope, the method further includes:
obtaining a tension value of the driving rope;
calculating friction between the driving rope and an elastic body based on the reference value of the soft welding gun tip pose; and
calculating a correction value of a welding gun tip attitude based on a preset elastic coefficient of the elastic body, the tension value of the driving rope, and the friction between the driving rope and the elastic body.

In one of the embodiments, the inputting to a welding gun pose estimation model, and solving to obtain a real-time pose of the soft welding gun tip includes:
inputting the reference value of the welding gun tip pose, the change value of the distance between the welding gun nozzle tip and the workpiece, and the correction value of the welding gun tip pose to the preset welding gun pose estimation model; and
solving, by using the welding gun pose estimation model, to obtain the real-time pose of the soft welding gun tip, where a formula is as follows:

$${P}_{f} = Γ ( {P}_{r} , Δ d , Δ D )$$

where P_{f} is the real-time pose of the soft welding gun tip, Γ(⋅) is a correction model of the soft welding gun tip pose, Pᵣ is the reference value of the welding gun tip pose, Δd is the correction value of the welding gun tip attitude, and ΔD is the change value of the distance between the welding gun nozzle tip and the workpiece.

In one of the embodiments, the reference value of the welding gun tip pose is calculated based on forward kinematics, where a formula is as follows:

$${P}_{r} = {T}_{G} Δ L$$

where Pᵣ is the reference value of the welding gun tip pose, T_{G} is a forward kinematics transfer matrix of the soft welding gun, and ΔL is the displacement of the driving rope.

In one of the embodiments, the calculating a correction value of a welding gun tip attitude includes:
calculating a deformation amount of the elastic body based on the tension value of the driving rope, and correcting the welding gun tip attitude based on the deformation amount of the elastic body, where a correction formula is as follows:

$$Δ d = k Ψ ( {f}_{i} - {F}_{μ i} )$$

where Δd is the correction value of the welding gun tip attitude, k is an elastic coefficient of the elastic body, Ψ( ) is a relationship between a force borne by the driving rope and an acting force at the soft welding gun tip, fᵢ is a tension borne by an i^{th} driving rope, and F_{μi} is friction between the i^{th} driving rope and the elastic body.

According to a third aspect, this application further provides a system for driving a soft welding gun. The system includes:
a driving rope displacement obtaining module, configured to obtain a displacement of a driving rope;
a welding gun pose reference calculation module, configured to calculate a reference value of a soft welding gun tip pose based on the displacement of the driving rope;
a welding gun current and voltage obtaining module, configured to obtain a welding current and a welding voltage;
a welding gun-workpiece distance calculation module, configured to calculate the change value of a distance between a welding gun nozzle tip and a workpiece based on the welding current and the welding voltage; and
a real-time pose solving module based on a pose model, configured to input the reference value of the welding gun tip pose and the change value of the distance between the welding gun nozzle tip and the workpiece to a preset welding gun pose estimation model, and solve to obtain a real-time pose of the soft welding gun tip.

According to a fourth aspect, this application further provides a computer device. The computer device includes a memory and a processor, where the memory has a computer program stored therein, and when the computer program is executed by the processor, the following steps are implemented:
obtaining a displacement of a driving rope;
calculating a reference value of a welding gun tip pose based on the displacement of the driving rope;
obtaining a welding current and a welding voltage;
calculating a change value of a distance between a welding gun nozzle tip and a workpiece based on the welding current and the welding voltage; and
inputting the reference value of the welding gun tip pose and the change value of the distance between the welding gun nozzle tip and the workpiece to a preset welding gun pose estimation model, and solving to obtain a real-time pose of the soft welding gun tip.

According to a fifth aspect, this application further provides a computer-readable storage medium. The computer-readable storage medium has a computer program stored therein, and when the computer program is executed by a processor, the following steps are implemented: obtaining a displacement of a driving rope;
calculating a reference value of a welding gun tip pose based on the displacement of the driving rope;
obtaining a welding current and a welding voltage;
calculating a change value of a distance between a welding gun nozzle tip and a workpiece based on the welding current and the welding voltage; and
inputting the reference value of the welding gun tip pose and the change value of the distance between the welding gun nozzle tip and the workpiece to a preset welding gun pose estimation model, and solving to obtain a real-time pose of the soft welding gun tip.

According to a sixth aspect, this application further provides a computer program product. The computer program product includes a computer program, and when the computer program is executed by a processor, the following steps are implemented:
obtaining a displacement of a driving rope;
calculating a reference value of a welding gun tip pose based on the displacement of the driving rope;
obtaining a welding current and a welding voltage;
calculating the change value of a distance between a welding gun nozzle tip and a workpiece based on the welding current and the welding voltage; and
inputting the reference value of the welding gun tip pose and the change value of the distance between the welding gun nozzle tip and the workpiece to a preset welding gun pose estimation model, and solving to obtain a real-time pose of the soft welding gun tip.

### 3. Beneficial Effects

By using the foregoing method in this application, all pieces of information obtained by sensors arranged at a driving rope end are implicit information, for example, a displacement of a rope, a tension of a rope, and an electric parameter for welding. No additional visual or position sensor needs to be arranged at a nozzle end. That is, delay-free online detection of a soft welding gun tip pose can be implemented in a confined space. Because no external visual sensor is used, a volume of a soft welding gun tip can be greatly reduced, making it more suitable for working conditions in a confined space.

### BRIEF DESCRIPTION OF THE DRAWINGS

FIG. 1 is a schematic structural diagram of a soft welding gun according to an embodiment;

FIG. 2 is a schematic structural diagram of a system for driving a soft welding gun according to an embodiment;

FIG. 3 is a flowchart of a method for driving a soft welding gun according to an embodiment;

FIG. 4 is a specific flowchart of a method for driving a soft welding gun according to an embodiment;

FIG. 5 is a structural block diagram of a system for driving a soft welding gun according to an embodiment; and

FIG. 6 is a diagram of an internal structure of a computer device according to an embodiment.

Reference signs: 100: welding machine; 200: welding cable; 300: nozzle; 400: elastic member; 500: driving rope; 600: rope tension measurement subsystem; 610: tension measurement instrument; 700: rope displacement measurement subsystem: 710: displacement measurement instrument; 800: upper computer; and 900: electrical parameter acquisition card.

### DETAILED DESCRIPTION

To make the objectives, technical solutions, and advantages of this application clearer and more comprehensible, the following further describes this application in detail with reference to the accompanying drawings and embodiments. It should be understood that the specific embodiments described herein are merely used for explaining this application, and are not intended to limit this application.

A soft welding gun provided in this application specifically includes: a welding machine 100. The welding machine 100 is electrically connected to a welding cable 200. A nozzle 300 is detachably connected to the end of the welding cable 200 away from the welding machine 100. An elastic member 400 is sleeved on the welding cable 200. A driving rope 500 for controlling extension and retraction of the elastic member 400 is connected to the nozzle 300. Specifically, the elastic member 400 is a spring in this embodiment.

The welding machine 100 is connected to an upper computer 800 by an electrical parameter acquisition card 900. A quantity of the driving ropes 500 is not limited. There are 3 driving ropes 500 in this embodiment, and each driving rope 500 is connected to a displacement measurement instrument 710 and a tension measurement instrument 610. The displacement measurement instrument 710 and the tension measurement instrument 610 are separately electrically connected to the upper computer 800, and are configured to send a measured displacement value and a measured tension value to the upper computer 800 for analysis and calculation. In this embodiment, a specific model of the electrical parameter acquisition card 900 is NI USB-6008, a specific model of the displacement measurement instrument 710 is HPS-1000 mm-V10, and a specific model of the tension measurement instrument 610 is ILBS-M2.

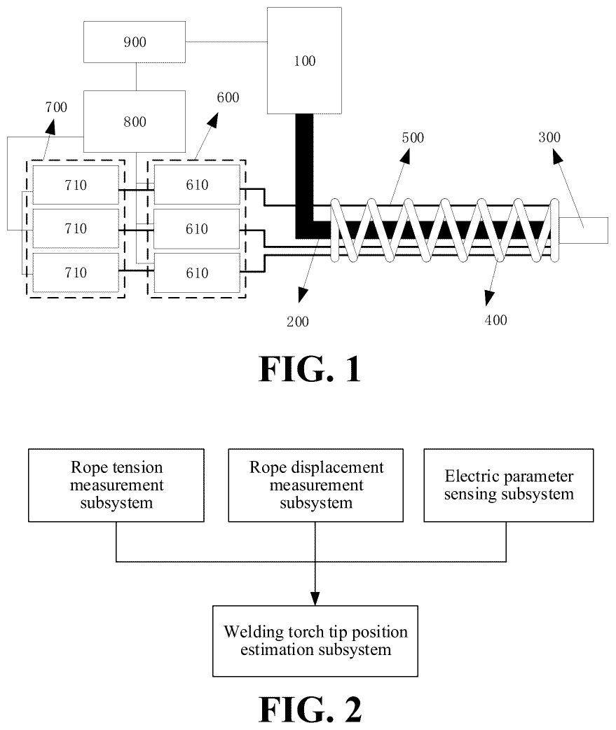

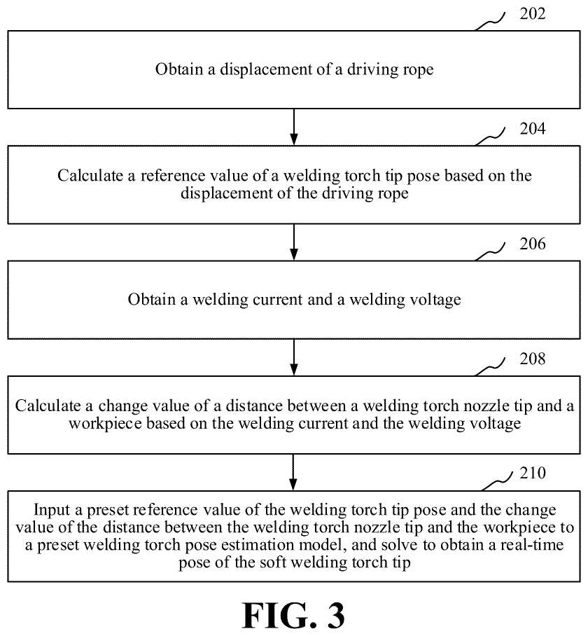

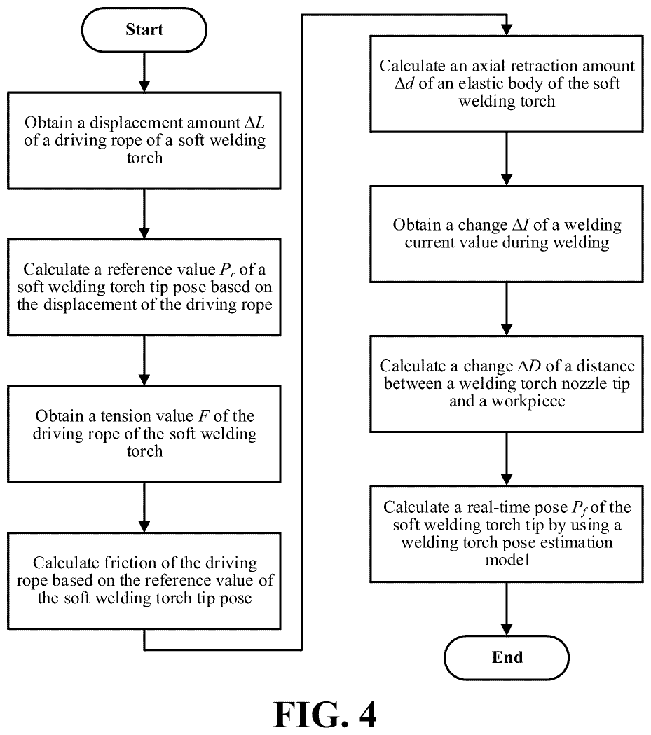

A method for driving the soft welding gun provided in this embodiment of this application may be applied to an application environment shown in FIG. 1. As shown in FIG. 1, FIG. 2, FIG. 3, and FIG. 4, a rope displacement measurement subsystem 700 is formed by three displacement measurement instruments 710 in this embodiment, and is configured to obtain a displacement of a driving rope 500. An angular displacement value of a servo motor is read by the displacement measurement instruments 710, and data is sent to an upper computer 800. A rope tension measurement subsystem 600 formed by three tension measurement instruments 610 is connected to the upper computer 800. The rope tension measurement subsystem 600 is configured to measure a tension borne by the driving rope 500, and send a measurement result to the upper computer 800. The electrical parameter sensing subsystem is formed by connecting an electrical parameter acquisition card 900 to a welding machine 100 and the upper computer 800, and is configured to acquire an electrical parameter and send a result to the upper computer 800. The upper computer 800 is a welding gun tip position estimation subsystem, and jointly estimates a welding gun tip pose by combining a reference value of the welding gun tip pose, a deformation amount of an elastic body, and a distance between a nozzle 300 and a workpiece. The method includes the following steps:

Step 202: Obtain a displacement of a driving rope.

The driving rope implements extension and retraction driven through a servo motor. The servo motor is electrically connected to the upper computer. The upper computer may detect an angular displacement data of the servo motor, and the upper computer converts the angular displacement data of the servo motor into the displacement of the driving rope.

Step 204: Calculate a reference value of a welding gun tip pose based on the displacement of the driving rope.

Step 206: Obtain a welding current and a welding voltage.

An arc parameter is associated with a height of a nozzle, and this characteristic can be used to represent a relative position between a soft welding gun and a workpiece. After an arc is started, a welding current and a welding voltage are read from an I/O interface of a welding machine by an electrical parameter acquisition card and an arc signal is transmitted to the upper computer.

Step 208: Calculate a change value of a distance between a welding gun nozzle tip and a workpiece based on the welding current and the welding voltage.

The upper computer estimates a distance between the welding gun tip and the workpiece by processing and analyzing the arc signal, to provide an correction value of the welding gun tip pose.

For example, when using a gas metal arc welding (GMAW) machine with constant voltage characteristics, the welding current and the distance between the welding gun nozzle tip and the workpiece have the following relationship:

$$I = - pD + q$$

where I is the welding current, D is the distance between the welding gun nozzle tip and the workpiece, p and q are preset constants, and need to be obtained through calibration before welding.

Step 210: Input a reference value of the soft welding gun tip pose and the change value of the distance between the welding gun nozzle tip and the workpiece to a preset welding gun pose estimation model, and solve to obtain a real-time pose of the soft welding gun tip.

In the foregoing method for driving a soft welding gun, the soft welding gun tip pose is deduced by measuring the displacement and the tension value of the driving rope, and no additional visual sensor is needed. Delay-free online detection of a position of the soft welding gun tip is implemented in a confined space condition, so that a volume of the welding gun tip can be greatly reduced.

In one of the embodiments, because the elastic body is prone to axial retraction under a rope control condition, there is an error in the welding gun tip pose calculated by using forward kinematics, and the error needs to be corrected. Specific correction operations include:

obtaining a displacement of a driving rope; calculating a reference value of a welding gun tip pose based on the displacement of the driving rope; obtaining a welding current and a welding voltage; calculating a change value of a distance between a welding gun nozzle tip and a workpiece based on the welding current and the welding voltage; and inputting the reference value of the welding gun tip pose and the change value of the distance between the welding gun nozzle tip and the workpiece to a preset welding gun pose estimation model, and solving to obtain a real-time pose of the soft welding gun tip.

The upper computer calculates a deformation amount of the elastic body according to the tension value of the driving rope, to provide a correction value of a welding gun tip attitude. The axial retraction of the elastic body is related to tensions borne by driving ropes, and can be calculated by using the following formulas:

$$F = [ {f}_{1} , {f}_{2} , {f}_{3} ]$$

where F is the tension borne by the rope, and f₁, f₂, and f₃ are the tensions borne by the three driving ropes; and

$$Δ d = k Ψ ( {f}_{1} - {F}_{μ1} , {f}_{2} - {F}_{μ2} , {f}_{3} - {F}_{μ3} )$$

where Δd is the correction value of the welding gun tip attitude, k is an elastic coefficient of the elastic body, Ψ( ) is a relationship between the forces borne by the driving ropes and an acting force at the soft welding gun tip, f₁, f₂, and f₃ are the tensions borne by the three driving ropes, F_{μ1}, F_{μ2}, and F_{μ3} are friction between the driving ropes and the elastic body, and the friction between the driving ropes and the elastic body is calculated by using the reference value of the current welding gun tip pose.

In this embodiment, the upper computer calculates the deformation amount of the elastic body based on the tension value of the driving rope, calculates the friction between the driving ropes and the elastic body according to the reference value of the current welding gun tip pose, and finally calculates the correction value of the welding gun tip attitude according to the tensions of the driving ropes and the friction between the driving ropes and the elastic body.

In one of the embodiments, the arc parameter is associated with the height of the nozzle, and the relative position between the soft welding gun and the workpiece may be represented by using the arc parameter. Specifically, the following steps are included:
after an arc is started, reading, by the electrical parameter acquisition card, a welding current and a welding voltage from the I/O interface of the welding machine, and transmitting an arc signal to the upper computer; and estimating, by the upper computer, a distance between the welding gun tip and the workpiece by processing and analyzing the arc signal, and providing an correction value of the welding gun tip pose.

For example, when using a gas metal arc welding (GMAW) machine with constant voltage characteristics, the welding current and the distance between the welding gun nozzle tip and the workpiece have the following relationship:

$$I = - pD + q$$

where I is a welding current, D is a distance between the welding gun nozzle tip and the workpiece, p and q are preset constants, and need to be obtained through calibration before welding.

During the welding, a change ΔD of the distance between the welding gun nozzle tip and the workpiece may be calculated based on the change ΔI of the welding current.

Finally, a real-time pose P_{f} of the soft welding gun tip is comprehensively solved by using the welding gun pose estimation model. For example, the real-time pose may be calculated by using the following formula:

$${P}_{f} = Γ ( {P}_{r} , Δ d , Δ D )$$

where P_{f} is the real-time pose of the soft welding gun tip, Γ′(⋅) is a correction model of the soft welding gun tip pose, Pᵣ is the reference value of the welding gun tip pose, Δd is the correction value of the welding gun tip attitude, and ΔD is the change value of the distance between the welding gun nozzle tip and the workpiece.

It should be noted that, in the present invention, a welding cable and the driving ropes may be extended. It can be seen that, all sensing apparatuses in the method in the present invention are deployed at a far end of the welding gun, and are far away from the welding gun nozzle. The welding gun tip pose is deduced according to implicit information in a welding process. In addition, no additional visual sensor is needed in the present invention. Delay-free online detection of a position of the soft welding gun tip is implemented in a confined space condition, so that a volume of the welding gun tip can be greatly reduced.

It should be understood that although the steps are displayed sequentially as indicated by arrows in flowcharts involved in the embodiments, these steps are not necessarily performed sequentially according to the sequence indicated by the arrows. Unless otherwise explicitly specified in this application, execution of the steps is not strictly limited, and the steps may be performed in other sequences. In addition, at least some steps in the flowcharts involved in the foregoing embodiments may include a plurality of steps or a plurality of stages, and these steps or stages are not necessarily performed at a same moment, but may be performed at different moments. The steps or stages are not necessarily performed in sequence, but may be performed by turn or alternately with other steps or at least part of steps or stages in other steps.

Based on the same inventive concept, an embodiment of this application further provides a system for driving a soft welding gun, to implement the foregoing method for driving a soft welding gun. An implementation provided by the apparatus for resolving the problems is similar to the implementation described in the foregoing method. Therefore, for specific limitations of one or more embodiments of an apparatus for driving a soft welding gun provided below, reference may be made to the limitations of the method for driving a soft welding gun above, and details are not described herein again.

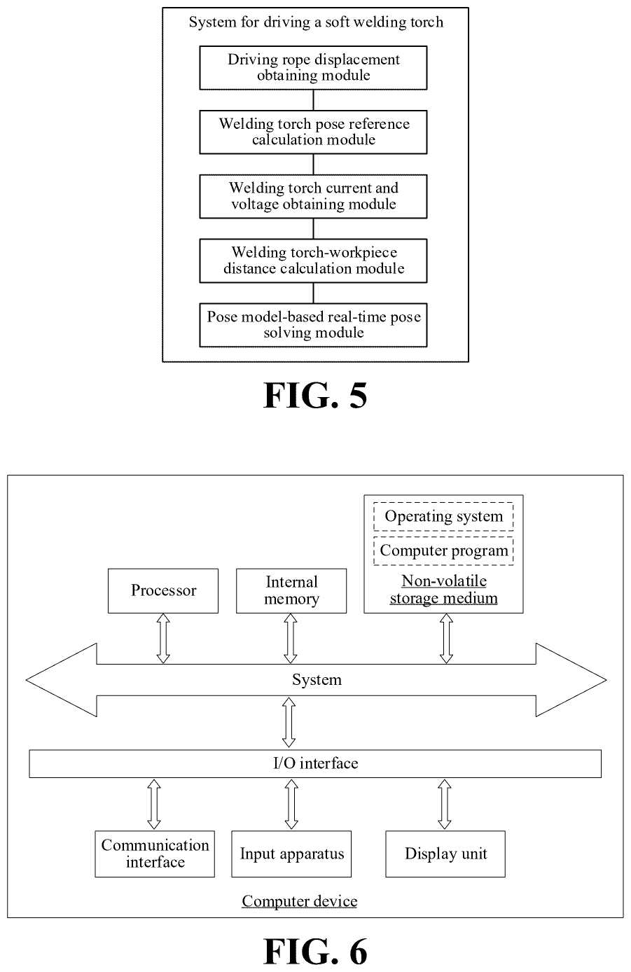

In one of the embodiments, as shown in FIG. 5, a system for driving a soft welding gun is provided, including: a driving rope displacement obtaining module, a welding gun pose reference calculation module, a welding gun current and voltage obtaining module, a welding gun-workpiece distance calculation module, and a real-time pose solving module based on the pose model, where:
the driving rope displacement obtaining module, configured to obtain a displacement of a driving rope;
a welding gun pose reference calculation module, configured to calculate a reference value of a welding gun tip pose based on the displacement of the driving rope;
the welding gun current and voltage obtaining module, configured to obtain a welding current and a welding voltage;
the welding gun-workpiece distance calculation module, configured to calculate a change value of a distance between a welding gun nozzle tip and a workpiece based on the welding current and the welding voltage; and
the real-time pose solving module based on the pose model, configured to input the reference value of the welding gun tip pose and the change value of the distance between the welding gun nozzle tip and the workpiece to a preset welding gun pose estimation model, and solve to obtain a real-time pose of the soft welding gun tip.

In an embodiment, the welding gun pose reference calculation module is further configured to: obtain a tension value of the driving rope; calculate friction between the driving rope and an elastic body based on the reference value of the welding gun tip pose; and calculate a correction value of a soft welding gun tip attitude based on a preset elastic coefficient of the elastic body, the tension value of the driving rope, and the friction between the driving rope and the elastic body.

In an embodiment, the welding gun pose reference calculation module is further configured to: input a reference value of the welding gun tip pose, the change value of the distance between the welding gun nozzle tip and the workpiece, and the correction value of the welding gun tip pose to the preset welding gun pose estimation model; solve, by using the welding gun pose estimation model, to obtain the real-time pose of the soft welding gun tip, where a formula is as follows: P_{f}=Γ(Pᵣ, Δd, ΔD), where P_{f} is the real-time pose of the soft welding gun tip, Γ(⋅) is a correction model of the soft welding gun tip pose, Pᵣ is the reference value of the welding gun tip pose, Δd is the correction value of the welding gun tip attitude, ΔD is the change value of the distance between the welding gun nozzle tip and the workpiece.

In an embodiment, the welding gun pose reference calculation module is further configured to: calculate the reference value of the welding gun tip pose based on forward kinematics, where a formula is as follows: Pᵣ=T_{G} ΔL, where Pᵣ is the reference value of the welding gun tip pose, T_{G} is a forward kinematics transfer matrix of the soft welding gun, and ΔL is the displacement of the driving rope.

In an embodiment, the welding gun pose reference calculation module is further configured to: calculate a deformation amount of the elastic body based on the tension value of the driving rope, and correct the welding gun tip attitude based on the deformation amount of the elastic body, where a correction formula is as follows: Δd=kΨ(fᵢ−F_{μi}); where Δd is the correction value of the welding gun tip attitude, k is an elastic coefficient of the elastic body, Ψ( ) is a relationship between a force borne by the driving rope and an acting force at the soft welding gun tip, fᵢ is a tension borne by an i^{th} driving rope, and F_{μi} is friction between the i^{th} driving rope and the elastic body.

The modules in the foregoing system for driving a soft welding gun may be implemented entirely or partially by software, hardware, or a combination thereof. The foregoing modules may be built in or independent of a processor of a computer device in a hardware form, or may be stored in a memory of a computer device in a software form, which helps the processor invoke and perform operations corresponding to the foregoing modules.

In an embodiment, a computer device is provided. The computer device may be a server, and an internal structural diagram thereof may be shown in FIG. 6. The computer device includes a processor, a memory, and an I/O interface that are connected by a system bus. The processor of the computer device is configured to provide computing and control capabilities. The memory of the computer device includes a non-volatile storage medium and an internal memory. The non-volatile storage medium has an operating system, a computer program, and a database stored therein. The internal memory provides an environment for running of the operating system and the computer program in the non-volatile storage medium. The database of the computer device is configured to store data. The I/O interface of the computer device is configured to communicate with an external terminal through a network connection. When the computer program is executed by the processor, a method for driving a soft welding gun is implemented.

In an embodiment, a computer device is provided. The computer device may be a terminal, and a diagram of an internal structural thereof may be shown in FIG. 6. The computer device includes a processor, a memory, a communication interface, a display screen, and an input apparatus that are connected by using a system bus. The processor of the computer device is configured to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The communication interface of the computer device is configured to communicate with an external terminal in a wired or wireless manner. The wireless communication may be implemented by Wi-Fi, a mobile cellular network, near field communication (NFC), or another technology. When the computer program is executed by the processor, a method for driving a soft welding gun is implemented. A person skilled in the art may understand that, the structure shown in FIG. 6 is only a block diagram of a part of a structure related to a solution of this application and does not limit the computer device to which the solution of this application is applied. Specifically, the computer device may include more or fewer components than those in the figure, or include a combination of some components, or include different component layouts.

In an embodiment, a computer device is provided, including a memory and a processor, where the memory has a computer program stored therein, and when the computer program is executed by the processor, the steps in the foregoing method embodiments are implemented.

In an embodiment, a computer-readable storage medium is provided, having a computer program stored therein, where when the computer program is executed by a processor, the steps in the foregoing method embodiments are implemented.

In an embodiment, a computer program product is provided, including a computer program, where when the computer program is executed by a processor, the steps in the foregoing method embodiments are implemented.

User information (including but not limited to user equipment information, user personal information, and the like) and data (including but not limited to data for analysis, stored data, displayed data, and the like) involved in this application both are information and data authorized by the user or fully authorized by all parties.

A person of ordinary skill in the art may understand that all or some of the processes of the methods in the embodiments may be implemented by indicating related hardware through a computer program. The computer program may be stored in a non-volatile computer-readable storage medium. When the computer program is executed, the processes of the foregoing method embodiments may be included. Any reference to the memory, the database, or another media used in embodiments provided by this application may include at least one of the non-volatile memory and the volatile memory. The non-volatile memory can include a read-only memory (Read-Only Memory, ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache memory, or the like. As an illustration rather than a limitation, the RAM may be in various forms, such as a static random access memory (SRAM) or a dynamic random access memory (DRAM). The databases involved in the various embodiments provided by this application may include at least one of a relational database and a non-relational database. The non-relational databases may include a blockchain-based distributed database, and the like, but is not limited thereto. The processor involved in the embodiments provided by this application may be a general-purpose processor, a central processing unit, a graphics processing unit, a digital signal processor, a programmable logic device, a quantum computing-based data processing logic device, and the like, but is not limited thereto.

The technical features in the foregoing embodiments may be randomly combined. For simplicity of description, all possible combinations of the technical features in the foregoing embodiments are not described. However, it should be considered that these combinations of technical features fall within the scope recorded in the specification provided that these combinations of technical features do not have any conflict.

The foregoing embodiments only describe several implementations of this application, and their descriptions are specific and detailed, but cannot therefore be understood as a limitation to the scope of the claims of this application. It should be noted that for persons of ordinary skill in the art, several variations and improvements may further be made without departing from the concept of this application. These variations and improvements should also be deemed as falling within the scope of protection of this application. Therefore, the scope of protection of this application shall be subject to the appended claims.

What is claimed is:

1. A method for driving the soft welding gun, comprising:
obtaining a displacement of the driving rope (500), in which the driving rope is connected to the nozzle (300) of the soft welding gun, and the driving rope is used to control the extension and retraction of the elastic member (400) sleeved on the welding cable (200);
calculating a reference value of a soft welding gun tip pose based on the displacement of the driving rope;
obtaining a tension value of the driving rope through the rope tension measurement subsystem (600) arranged on the driving rope;
calculating friction between the driving rope and an elastic body based on the reference value of the soft welding gun tip pose;
calculating a correction value of a soft welding gun tip attitude through the upper computer (800) based on a preset elastic coefficient of the elastic body, the tension value of the driving rope, and the friction between the driving rope and the elastic body;
obtaining a welding current and a welding voltage through the electrical parameter acquisition card (900) arranged on the welding cable;
calculating a change value of a distance between a soft welding gun nozzle tip and a workpiece based on the welding current and the welding voltage;
inputting the preset reference value of the welding gun tip pose, the change value of the distance between the soft welding gun nozzle tip and the workpiece, and the attitude correction value of the welding gun tip pose to the preset welding gun pose estimation model; and
solving, by using the welding gun pose estimation model, to obtain the real-time pose of the soft welding gun tip, wherein a formula is as follows:
$${P}_{f} = Γ ( {P}_{r} , Δ d , Δ D )$$
wherein P_{f} is the real-time pose of the soft welding gun tip, Γ(⋅) is a correction model of the soft welding gun tip pose, Pᵣ is the reference value of the welding gun tip pose, Δd is the correction value of the welding gun tip attitude, and ΔD is the change value of the distance between the welding gun nozzle tip and the workpiece.

2. The method for driving a soft welding gun according to claim 1, wherein the calculating a reference value of a soft welding gun tip pose based on the displacement of the driving rope comprises:
calculating the reference value of the soft welding gun tip pose based on forward kinematics, wherein a formula is as follows:
$${P}_{r} = {T}_{G} Δ L$$
wherein Pᵣ is the reference value of the soft welding gun tip pose, T_{G} is a forward kinematics transfer matrix of the soft welding gun, and ΔL is the displacement of the driving rope.

3. The method according to claim 1, wherein the calculating a correction value of the soft welding gun tip attitude comprises:
calculating a deformation amount of the elastic body based on the tension value of the driving rope, and correcting the welding gun tip attitude based on the deformation amount of the elastic body, wherein a correction formula is as follows:
$$Δ d = k Ψ ( {f}_{i} - {F}_{μ i} )$$
wherein Δd is the correction value of the welding gun tip attitude, k is an elastic coefficient of the elastic body, Ψ( ) is a relationship between a force borne by the driving rope and an acting force at the soft welding gun tip, fᵢ is a tension borne by an i^{th} driving rope, and F_{μi} is friction between the i^{th} driving rope and the elastic body.

4. An apparatus for driving a soft welding gun, wherein the apparatus comprises:
a driving rope displacement obtaining module, configured to obtain a displacement of a driving rope, in which the driving rope is connected to the nozzle of the soft welding gun, and the driving rope is used to control the extension and retraction of the elastic member sleeved on the welding cable;
a welding gun pose reference calculation module, configured to calculate a reference value of a welding gun tip pose based on the displacement of the driving rope;
a welding gun current and voltage obtaining module, configured to obtain a welding current and a welding voltage;
a welding gun-workpiece distance calculation module, configured to calculate a change value of a distance between a soft welding gun nozzle tip and a workpiece based on the welding current and the welding voltage; and
a real-time pose solving module based on the pose model, configured to input the reference value of the soft welding gun tip pose and the change value of the distance between the soft welding gun nozzle tip and the workpiece to a preset welding gun pose estimation model, and solve to obtain a real-time pose of the soft welding gun tip.

5. The apparatus for driving a soft welding gun according to claim 4, wherein the welding gun pose reference calculation module is further configured to:
obtain a tension value of the driving rope; calculate friction between the driving rope and an elastic body based on the reference value of the welding gun tip pose; and calculate a correction value of a soft welding gun tip attitude based on a preset elastic coefficient of the elastic body, the tension value of the driving rope, and the friction between the driving rope and the elastic body.

6. The apparatus for driving a soft welding gun according to claim 4, wherein the welding gun pose reference calculation module is further configured to:
input a reference value of the welding gun tip pose, the change value of the distance between the welding gun nozzle tip and the workpiece, and the correction value of the welding gun tip pose to the preset welding gun pose estimation model; solve, by using the welding gun pose estimation model, to obtain the real-time pose of the soft welding gun tip, where a formula is as follows:
P_{f}=Γ(Pᵣ, Δd, ΔD), where P_{f} is the real-time pose of the soft welding gun tip, Γ(⋅) is a correction model of the soft welding gun tip pose, Pᵣ is the reference value of the welding gun tip pose, Δd is the correction value of the welding gun tip attitude, ΔD is the change value of the distance between the welding gun nozzle tip and the workpiece.

7. The apparatus for driving a soft welding gun according to claim 4, wherein the welding gun pose reference calculation module is further configured to:
calculate the reference value of the welding gun tip pose based on forward kinematics, where a formula is as follows:
Pᵣ=T_{G}ΔL, where Pᵣ is the reference value of the welding gun tip pose, T_{G} is a forward kinematics transfer matrix of the soft welding gun, and ΔL is the displacement of the driving rope.

8. The apparatus for driving a soft welding gun according to claim 4, wherein the welding gun pose reference calculation module is further configured to:
calculate a deformation amount of the elastic body based on the tension value of the driving rope, and correct the welding gun tip attitude based on the deformation amount of the elastic body, where a correction formula is as follows:
Δd=kΨ(fᵢ−F_{μi}); where Δd is the correction value of the welding gun tip attitude, k is an elastic coefficient of the elastic body, Ψ( ) is a relationship between a force borne by the driving rope and an acting force at the soft welding gun tip, fᵢ is a tension borne by an it driving rope, and F_{μi} is friction between the i^{th} driving rope and the elastic body.

9. A computer device, comprising a memory and a processor, wherein the memory has a computer program stored therein, and when the computer program is executed by the processor, the steps of the method according to claim 1 are implemented.
